(19) United States
(12) Patent Application Publication
(10) Pub. No.: US 2009/0304078 A1
(43) Pub. Date: Dec. 10, 2009

(54) VARIABLE LENGTH DECODER AND ANIMATION DECODER THEREWITH

(75) Inventors: Takafumi YUASA, Musashino (JP); Hiroaki NAKATA, Yokohama (JP); Fumitaka IZUHARA, Kokubunji (JP); Kazushi AKIE, Kokubunji (JP); Motoki KIMURA, Techikawa (JP)

Correspondence Address: MILES & STOCKBRIDGE PC, 1751 PINNACLE DRIVE, SUITE 500, MCLEAN, VA, 22102-3833, US

(73) Assignee: RENESAS TECHNOLOGY CORP.

(21) Appl. No.: 12/473,950

(22) Filed: May 28, 2009

(30) Foreign Application Priority Data
Jun. 4, 2008 (JP) 2008-146630

(51) Int. Cl. H04N 7/26

(52) U.S. Cl. 375/240.12; 375/240.23; 375/E07.144; 375/E07.243

(57) ABSTRACT

The variable length decoder has a memory device including a plurality of lookup tables, and sequentially decodes codewords of variable-length codes using the memory device. The decoded values corresponding to the codewords and control information pieces are stored in the lookup tables. In decoding one codeword, one lookup table is selected from among the plurality of lookup tables. In the decode, one decoded value corresponding to the one codeword, and a control information piece for selecting a next lookup table depending on the decoded value and used for a next decode are produced from the selected lookup table in response to the one codeword in parallel.

### CLAIM OF PRIORITY

The Present application claims priority from Japanese application JP 2008-146630 filed on Jun. 4, 2008, the content of which is hereby incorporated by reference into this application

### FIELD OF THE INVENTION

The present invention relates to a variable-length-decoding device and a moving-picture-decoding device using the same. Particularly, it relates to a technique useful in executing a high-speed real time decoding.

### BACKGROUND OF THE INVENTION

Currently, moving-picture coding systems including MPEG-2 and MPEG-4 defined by MPEG (Moving Picture Expert Group) have been in common use as moving-picture coding systems worldwide. H.264/AVC has been an up-to-date video international standard coding, which has been authorized as a recommended H.264 of ITU-T (International Telecommunication Union Telecommunication Standardization Sector), and also authorized as an international standard 14496-10 (MPEG part 10) Advanced Video Coding (AVC) by ISO/IEC (International Organization for Standardization/International Electrotechnical Commission).

A video-coding technique compliant with the recommended H.264/AVC is described in Non-patent Document 1 presented by Thomas Wiegand et al., “Overview of the H.264/AVC Video Coding Standard”, IEEE TRANSACTIONS ON CIRCUITS AND SYSTEMS FOR VIDEO TECHNOLOGY, JULY 2003, PP. 1-19. Video coding based on the recommended H.264/AVC takes a structure composed of a video coding layer designed to express effectively video contexts and a network abstraction layer designed to provide header information for format of VCL expressions of video and transfer through various transfer layers and recording media using an appropriate method. According to the recommended H.264/AVC, there are restrictions in bit stream and syntax (the rule of coded data and the structuring method thereof) so that all of decoders compliant with the standards generate similar outputs on receipt of supply of a coding bit stream pursuant to the standards, and only decoders are standardized by restricting a coding process of a syntax element. Incidentally, a syntax element refers to a piece of information transmitted in a syntax, such as a DCT coefficient or a motion vector.

Further, it is described in Non-patent Document 2 presented by GARY J. SULLIVAN et al., “Video Compression-From Concept to the H.264/AVC Standard”, PROCEEDING OF THE IEEE, VOL. 93, No. 1, JANUARY 2005, PP. 18-31 that VCL (Video Coding Layer) based on H.264/AVC adheres to an approach referred to as “block-based hybrid video coding”. In terms of the design, VCL is composed of a macroblock, a slice and a slice block, each picture is divided into a plurality of macroblocks with a fixed size, and each macroblock includes a quadrangular picture region of 16×16 samples in terms of luma components, and a quadrangular sample region for each of two chroma components corresponding to it. In the Inter-Picture Prediction, a macroblock can be partitioned into small regions of luma block sizes of 16×16, 16'8, 8×16 and 8×8 samples for MCP (Motion-Compensated Prediction). In case that the 8×8 macroblock type is selected, an additional syntax element for specifying whether to further divide a 8×8-block portion, which results from the 8×8 block, into 8×4, 4×8 and 4×4 luma samples and corresponding chroma components is transmitted for each 8×8-division portion. Also, in the recommended H.264/AVC, DCT (Discrete Cosine Transform) is applied to not a large block of 8×8 samples based on the prior standards but small blocks of 4×4 samples.

Further, it is described in Non-patent Document 1 by Thomas Wiegand et al. that two types of entropy coding (or variable codeword length coding) are prepared in the recommended H.264/AVC, and in simple entropy coding, a single unrestricted code table for all the syntax elements except quantization-transform coefficients is used, and the single code table contains exponential Golomb codes having a very simple and orderly decode dependence. Also, the use of a more efficient coding technique referred to as “CAVLC (Context-Adaptive Variable Length Coding)” for quantization-transform coefficients is described in Non-patent Document 1. According to CAVLC, VLC table for various syntax elements is switched depending on an already transmitted syntax element. With the CAVLC entropy coding method, the number of non-zero coefficients, actual sizes, and the positions of coefficients are coded individually. Seeing the statistical distribution of transform coefficients after zigzag scan, the coefficients take a large value in a low-frequency portion, and they decrease to a small value in a high-frequency portion in the latter half of the scan. Based on the statistical tendency, the number of non-zero coefficients, the trailing ones' number, coefficients' values, sign information, and data information of a total zeros' number and run-before value are used to transmit quantization-transform coefficients of luma 4×4 blocks. The number of non-zero coefficients is a total number of non-zero coefficients of 16 DCT coefficients. The trailing ones' number is the number of coefficients whose absolute values are equal to “1” at the end of the scan. The coefficient values are coded using exponential Golomb codes. The sign information uses one bit to show the sign of a coefficient, and the one bit is transferred alone because of trailing ones' number. As to other coefficients, sign bits are contained in exponential Golomb codes. The total zeros' number is a total number of non-zero coefficients between the start and end of the scan. Run before means the number of zero runs-before value each non-zero coefficient.

Now, Non-patent Document 3 presented by Yong Ho Moon et al., “An Efficient Decoding of CAVLC in H.264/AVC Video Coding Standard”, IEEE Transactions on Consumer Electronics, Vol. 51, No. 3, August 2005, PP. 933-938, the following describes as follows. In general, lots of memory accesses are required for decode pursuant to CAVLC based on H.264/AVC. Further, a decoder according to CAVLC uses a lookup table is used for decode of syntax elements. Besides, the power consumption and the complexity of calculations make the design of today's actual systems extremely difficult. Hence, Non-patent Document 3 presented by Yong Ho Moon et al. describes VLD (Variable-Length Decoding), in which a bit streams is decoded without using a lookup table and a codeword is directly decoded by an integer arithmetic operation.

### SUMMARY OF THE INVENTION

In recent years, for devices which process multimedia data such as images and voice and sound, a digital data compressing/encoding technique standardized as a standard for Codec representing encode and decode has been used to efficiently deal with multimedia data. For instance, MPEG-2, H.264/AVC and VC-1 are adopted as Codec for e.g. next-generation optical discs including Blue-ray Disc and HD-DVD, and MPEG-2 for television ground digital broadcasting.

According to any of such Codec standards, a process of VLC (Variable codeword Length Coding) is performed inside a device. In the process of variable codeword length coding, the average codeword length is curtailed thereby reducing the total data amount by assigning a codeword with a shorter bit length to data higher in uprise frequency, and a codeword with a longer bit length to data lower in uprise frequency. In the process of variable codeword length coding, the bit length varies on an individual codeword basis, and decoding steps are handled sequentially. Therefore, the process of variable codeword length coding needs a technique for enhancement of the performance of the coding process.

Codec standards define the data structure of bit streams, and which variable-length codes to use for coding respective data as syntax (rules of coded data and structuring ways thereof). At the time of decode, a variable-length-decoding device, i.e. so-called decoder decodes a variable-length code according to the syntax defined by Codec standards. Each datum subjected to variable codeword length coding is referred to as a syntax element.

As syntax elements have been already coded by variable-length codes, the bit lengths vary on an individual codeword basis. As described in Non-patent Document 1 by Thomas Wiegand et al., in decode by means of CAVLC of H.264/AVC, unless decode of a syntax element is completed, the first bit position of the subsequent syntax element is not decided. In addition, according to the result of decode of a syntax element, the type of the subsequent syntax element and the decoding method thereof can be changed, which depends on the syntax. Therefore, the decoding process is sequential. That is, in syntax processing and variable-length coding pursuant to Codec standards, unless decode of a syntax element is finished, decode of the subsequent syntax element cannot be started. As described above, the decoding process is sequential, and the syntax has a structure that depends on a result of decode of a syntax element, and as such, the processing performance declines in case that after completion of decode of the codeword of a syntax element, a syntax analysis using the decoded value thereof is needed immediately.

Further, in recent years, various Codec standards, such as MPEG-2, MPEG-4 and H.264/AVC have been adopted in diverse fields. Therefore, devices operable to process multimedia data have been required to support Multi-Codec that each hardware device deals with more than one Codec in isolation. Possible means to cope with Multi-Codec include an approach of individually designing hardware pieces which support Codec standards, and then integrating the hardware pieces thus designed into one hardware structure, and an approach of introducing a software process. The former approach allows a sufficient performance to be developed readily, but needs hardware pieces corresponding in number to Codec standards, and therefore tends to enlarge the logic scale. The latter approach copes with Multi-Codec flexibly by means of a software process, but has a difficulty in achieving a sufficient processing performance in comparison to the former approach.

Now, with regard to quantization-transform coefficients of luma 4×4 blocks, a case that a variable-length-decoding device (i.e. decoder) compliant with H.264/AVC decodes a run-before value will be described, provided that the run-before value refers to the number of zero runs-before value a non-zero coefficient. In such case, the decoder first decodes the total zeros' number, and then uses a zerosLeft, which has not been decoded, at time of decoding the run-before value of a non-zero coefficient of interest based on the total zeros. The initial value of the zerosLeft is the total zeros' number. The decoder updates the zeroLeft based on a result of decode of a run-before value obtained by decoding a codeword of a bit stream thereby to prepare for decode of the subsequent run-before value.

FIG. 1 is a diagram for explaining the process of forming a coding bit stream of quantization-transform coefficients of luma 4×4 blocks in a variable-length-coding device compliant with H.264/AVC, and the way of decoding a coding bit stream in a variable-length-decoding device compliant with H.264/AVC. Now, it is noted that FIG. 1 corresponds to the drawing concerning a CAVLC decode process contained in Non-patent Document 3 presented by Yong Ho Moon et al. Also, FIG. 1 shows the way of decoding a run-before value and the way of updating a zeroLeft for decoding the subsequent run-before value in connection with quantization-transform coefficients of luma 4×4 blocks.

As shown in FIG. 1, on quantization-transform coefficients 1000 of luma 4×4 blocks, a zigzag scan is executed in the order 0, 3, 0, 1, −1, −1, 0, 1, 0, and so on. Consequently, the number of non-zero coefficients (TotalCoeffs) is 5, the total zeros' number (TotalZeros) is 3, and the trailing ones' number (Trailingones) is 3.

Here, the actual trailing ones' number is 4, however the last fourth one is shown by the level of +1. This information is coded with a syntax element of Coeff_token. According to the H.264/AVC standards, the codeword thereof is made “0000100”, and the variable-length-decoding device compliant with H.264/AVC decodes the codeword thereby to create “x,x,″1″,|1|,|1|”.

As the sign of the trailing one of “1” at the eighth point of the zigzag scan is “+”, this information is coded with a syntax element of Sign of T1, and the codeword thereof is made “0” according to the H.264/AVC standards. Then, the variable-length-decoding device compliant with H.264/AVC decodes the codeword thereby to create “|1|,|1|,|1”.

As the sign of the trailing one of “−1” at the sixth point of the zigzag scan is “−”, this information is coded with the syntax element of Sign of T1, and the codeword thereof is made “1” according to the H.264/AVC standards. Then, the variable-length-decoding device compliant with H.264/AVC decodes the codeword thereby to create “|1|,|1|,1”.

As the sign of the trailing one of “−1” at the fifth point of the zigzag scan is also “−”, this information is coded with the syntax element of Sign of T1, and the codeword thereof is made “1” according to the H.264/AVC standards. Then, the variable-length-decoding device compliant with H.264/AVC decodes the codeword thereby to create “−1,−1,1”.

The last trailing one of “1” at the fourth point of the zigzag scan is coded with a syntax element of level_prefix/level_suffix (coefficient value), and the codeword thereof is made “1” according to the H.264/AVC standards. Then, the variable-length-decoding device compliant with H.264/AVC decodes the codeword thereby to create “1,−1,−1,1”.

The non-zero coefficient of “+3” at the second point of the zigzag scan is coded with the syntax element of level_prefix/level_suffix (coefficient value), and the codeword thereof is made “0010” according to the H.264/AVC standards. Then, the variable-length-decoding device compliant with H.264/AVC decodes the codeword thereby to create “3,1,−1,−1,1”.

The total zeros' number of 3 is coded with a syntax element of Total_zeros, and the codeword thereof becomes “111” according to the H.264/AVC standards. Then, the variable-length-decoding device compliant with H.264/AVC decodes the codeword thereby to create “0,0,0”, and combines it with the last decode result “3,1,−1,−1,1” thereby to create, as a new decode result, “0,0, 0|,3,1,−1,−1,1”.

The run-before value (the number of zero runs: 1) for “0” among three zeros figured in the total zeros' number, which is at the seventh point of the zigzag scan just before the last trailing one, i.e. the non-zero coefficient “1” at the eighth point of the zigzag scan, is coded with a syntax element of run_before. Then, the codeword thereof is made “10” according to the H.264/AVC standards. The variable-length-decoding device compliant with H.264/AVC recognizes from the codeword that the third zero of zeros figured in the total zeros' number is located before the non-zero coefficient at the eighth point of the zigzag scan, and then it creates, as a decode result, “0,0|,3,1,−1,−1,0,1”.

The run-before value showing that the second zero of zeros figured in the total zeros' number (the number of zero runs is 0) is not located just before the non-zero coefficient “−1” at the sixth point of the zigzag scan, which is figured in the trailing ones' number, is also coded with the syntax element of run_before. Then, the codeword thereof is made “1” according to the H.264/AVC standards. The variable-length-decoding device compliant with H.264/AVC recognizes from the codeword that the second zero of zeros figured in the total zeros' number is not located before the non-zero coefficient “−1” at the sixth point of the zigzag scan, and therefore it creates, as a decode result, “0,0|,3,1,−1,−1,0,1”.

The run-before value showing that the second zero of zeros figured in the total zeros' number (the number of zero runs is 0) is not located just before the non-zero coefficient “−1” at the fifth point of the zigzag scan, which is figured in the trailing ones' number, is also coded with the syntax element of run_before. Then, the codeword thereof is made “1” according to the H.264/AVC standards. The variable-length-decoding device compliant with H.264/AVC recognizes from the codeword that the second zero of zeros figured in the total zeros' number is not located before the non-zero coefficient “−1” at the fifth point of the zigzag scan, and therefore it creates, as a decode result, “0,0|,3,1,−1,−1,0,1”.

The run-before value showing that the second zero of zeros figured in the total zeros' number (the number of zero runs is 1) is located just before the non-zero coefficient “1” at the fourth point of the zigzag scan, which is figured in the trailing ones' number, is coded with the syntax element of run_before. Then, the codeword thereof is made “01” according to the H.264/AVC standards. The variable-length-decoding device compliant with H.264/AVC recognizes from the codeword that only the second zero of zeros figured in the total zeros' number is located alone before the non-zero coefficient “1” at the fourth point of the zigzag scan. At the same time, the variable-length-decoding device compliant with H.264/AVC recognizes that the first zero of zeros figured in the total zeros' number is located just before the non-zero coefficient “3” at the second point of the zigzag scan, and then it creates, as a final decode result, “0|,3,0,1,−1,−1,0,1”. In this way, as shown in FIG. 1, the 16 DCT coefficients “0,3,0,1,−1,−1,0,1,0,0,0,0,0,0,0,0” of the quantization-transform coefficients 1000 can be decoded correctly even after having been coded.

In the decode process described with reference to FIG. 1, the sign of each coefficient figured in the trailing ones' number, and the Level of a non-zero coefficient are skillfully-configured codewords, and therefore they can be decompressed by some arithmetic operation. However, for decode of other syntax elements, it is necessary to use a lookup table to be implemented by a memory.

FIG. 2 is a diagram showing a structure of part of a variable-length-decoding device using a lookup table to execute the decode of a run-before value in connection with a quantization-transform coefficient as shown in FIG. 1, and the update of the zerosLeft for decoding the subsequent run-before value, which the inventors examined prior to the invention.

The structure of the part of the variable-length-decoding device shown in FIG. 2 includes a memory 1001 and an access-control unit 1002. The memory 1001 can be included in a RAM (Random Access Memory) with a built-in LSI physically. However, logically it is formed by at least 14 lookup tables LUT1, LUT2, LUT3, . . . , LUT12, LUT13 and LUT14 for decode of run-before values.

With the variable length coding technique compliant with H.264/AVC, there are up to 14 zeros in total for 16 DCT coefficients. The fourteenth lookup table LUT14 is used to decode a codeword resulting from encode of the run-before value (Run before) in connection with, of 14 zeros representing a maximum total zeros' number of 14, zero just before a non-zero coefficient at the end of the zigzag scan (the number of zero runs is between 1 to 14). In the step of decoding a run-before value (Run before) of each non-zero coefficient, which is the number of zero runs before the non-zero coefficient, the variable-length-decoding device decodes the total zeros' number first, and then uses a zerosLeft, which has not been decoded, at time of decoding the run-before value of the non-zero coefficient of interest based on the total zeros' number. The initial value of the zerosLeft is the total zeros' number. The variable-length-decoding device updates the zeroLeft based on a result of decode of a run-before value obtained by decoding a codeword of a bit stream thereby to prepare for decode of the subsequent run-before value.

Hence, in the decoding device of FIG. 2, the total zeros' number representing the initial value of the zerosLeft is supplied to the access-control unit 1002. In case that the total zeros' number is the maximum of 14 showing 14 zeros, the access-control unit 1002 supplies the lookup table LUT14 with an initial value of a pointer address LA14 for indicating the fourteenth lookup table LUT14 in response to the value of 14, i.e. the maximum of the total zeros' number. In response to a codeword 1003 resulting from encode of a run-before value, which shows the number of zero runs just before a non-zero coefficient and takes on a value between 0 and 14, the lookup table LUT14 forms, as a result of decode, a decoded value (Value) 1004.

The decoded value 1004 resulting from the first decode shows a value between 0 and 14 as the number of zero runs just before a non-zero coefficient. Therefore, it is required to update the zerosLeft to prepare for decode of the subsequent run-before value based on the decoded value 1004. Hence, to update the zerosLeft, and therefore renew the total zeros' number (Total zeros), the arithmetic and logic unit (ALU) of the access-control unit 1002 subtracts the decoded value 1004 from a value of the pointer address LA14 corresponding to the total zeros' number equal to the initial value of the zerosLeft. The result of an operation by the arithmetic and logic unit (ALU) of the access-control unit 1002 shows the zerosLeft after update. One of the lookup tables LUT1 to LUT14 indicated by one of the pointer addresses LA1-LA14, which is equal to the zerosLeft after update, is used to decode a codeword 1003 resulting from encode of the subsequent run-before value. In this way, decode of a run-before value, update of the zerosLeft for decode of the subsequent run-before value, and decode of a codeword resulting from encode of the subsequent run-before value can be executed.

However, the inventors have revealed a problem of the structure shown in FIG. 2 that it takes a appreciable operation time of the arithmetic and logic unit (ALU) of the access-control unit 1002, and has a difficulty in executing a high-performance real time decode of variable-length codes of moving images.

Also, it has been clearly shown with the structure shown in FIG. 2 that the variable-length decode compliant with H.264/AVC can be executed readily, however the variable-length decode of contents based on other moving-picture coding systems except MPEG-2 and MPEG-4 cannot be conducted easily.

The invention was made after examination by the inventors prior to the invention as described above.

Therefore, it is an object of the invention to make easier or readier to execute the high-performance real time decode of variable-length codes. Also, it is another object of the invention to make easier or readier the variable-length decode of contents based on various coding systems.

The above and other objects of the invention, and novel features thereof will be apparent from the description hereof and the accompanying drawings.

Of the invention herein disclosed, a preferred embodiment is as follows in brief.

That is, a variable-length-decoding device according to a preferred embodiment of the invention has a memory device (1001) including a plurality of lookup tables (LUT1˜LUT14) (see FIG. 3), and sequentially decodes codewords (1003) of variable-length codes using the memory device.

In the lookup tables, decoded values (1004) and control information pieces (1005) corresponding to the codewords (1003) are stored (see FIG. 4). In decoding one codeword (“10”; 1003), one lookup table (LUT3) is selected from among the lookup tables.

In this step of decoding, one decoded value (“1”; 1004) corresponding to the one codeword, and a control information piece (“LA2”; 1005) for selecting a subsequent lookup table (LUT2) to be used for the subsequent decode depending on the decoded value are created in parallel from the selected lookup table, in response to the one codeword.

Now, an effect achieved by the preferred embodiment of the invention herein disclosed will be described below in brief.

That is, the high-performance real time decode of variable-length codes can be executed easily or readily.

### BRIEF DESCRIPTION OF THE DRAWINGS

FIG. 1 is a diagram for explaining the process of forming a coding bit stream of quantization-transform coefficients of luma 4×4 blocks in a variable-length-coding device compliant with H.264/AVC, and the way of decoding a coding bit stream in a variable-length-decoding device compliant with H.264/AVC;

FIG. 2 is a diagram showing a structure of part of a variable-length-decoding device using a lookup table to execute the decode of a run-before value for a quantization-transform coefficient as shown in FIG. 1, and the update of the zerosLeft for decoding the subsequent run-before value, which the inventors examined prior to the invention;

FIG. 3 is a diagram showing a structure of part of a variable-length-decoding device according to an embodiment of the invention, which is intended to execute the decode of a run-before value in connection with a quantization-transform coefficient as shown in FIG. 1 and the update of the zerosLeft for decoding the subsequent run-before value;

FIG. 4 is a diagram showing a structure of the memory 1001 in the structure of part of the variable-length-decoding device shown in FIG. 3, which includes 14 lookup tables for outputting, in parallel, a decoded value and next pointer address in response to a codeword;

FIG. 5 is a diagram showing relations among the decoded value of a run-before value to be decoded using the structure of part of the variable-length-decoding device shown in FIG. 3, the initial value of the zerosLeft before decode and the codeword resulting from encode of a run-before value;

FIGS. 6A-6D are diagrams showing structures of the fourteenth to eleventh memory regions in the memory of FIG. 4, which are specified by the fourteenth to eleventh pointer addresses respectively;

FIGS. 7A-7D are diagrams showing structures of the tenth to seventh memory regions in the memory of FIG. 4, which are specified by the tenth to seventh pointer addresses respectively;

FIGS. 8A-8F are diagrams showing structures of the sixth to first memory regions in the memory of FIG. 4, which are specified by the sixth to first pointer addresses respectively;

FIG. 9 is a diagram showing a structure of a moving-picture-decoding device compliant with H.264/AVC according to a specific embodiment of the invention;

FIG. 10 is a diagram showing a progressive frame and an interlaced frame, which are decided by a coded video sequence of VCL of H.264/AVC;

FIG. 11 is a diagram showing a slice of a picture compliant with H.264/AVC, a partition into macroblocks, and an intra-frame prediction;

FIG. 12 is a diagram showing the way a block of 4×4 samples is predicted from a sample located spatially near to the block in a prediction mode PM in connection with intra-frame prediction compliant with H.264/AVC;

FIG. 13 is a diagram showing that one macroblock is further divided into smaller regions for a motion-compensated prediction compliant with H.264/AVC at the time when the inter prediction unit of the moving-picture-decoding device shown in FIG. 9 performs an inter-frame prediction; and

FIG. 14 is a diagram showing a H.264/AVC multipicture motion-compensated prediction.

### DETAILED DESCRIPTION OF THE PREFERRED EMBODIMENTS

### 1. Summary of the Preferred Embodiments

First, the preferred embodiments of the invention herein disclosed will be outlined. Here, the reference numerals, characters and signs for reference to the drawings, which are accompanied with paired round brackets, only exemplify what the concepts of components and elements referred to by the numerals, characters and signs contain.

[1] A variable-length decoder according to a preferred embodiment of the invention has a memory device (1001) including a plurality of lookup tables (LUT1 to LUT14) (see FIG. 3), and is capable of sequentially decoding codewords (1003), which have been encoded by variable-length coding, using the memory device.

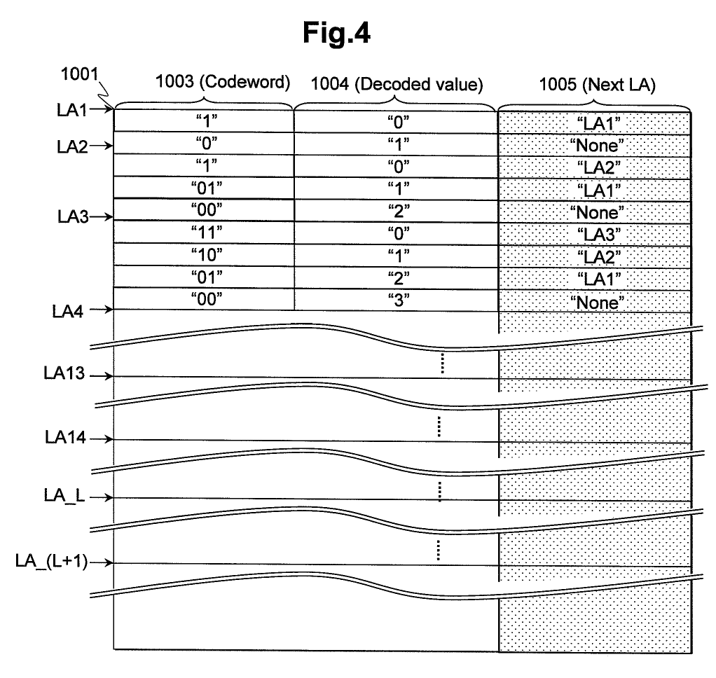

In the plurality of lookup tables, decoded values (1004) corresponding to the codewords (1003) and control information pieces (1005) can be stored (see FIG. 4).

In decoding one code word (“10”; 1003) of the codewords, one lookup table (LUT3) is selected from among the plurality of lookup tables.

In the decode of the one codeword, one decoded value (“1”; 1004) corresponding to the one codeword, and a control information piece (“LA2”; 1005) for selecting, from among the plurality of lookup tables, a next lookup table (LUT2) depending on the one decoded value and used for a next decode are produced from the one lookup table in response to the one codeword in parallel.

According to the above embodiment, in decoding a codeword (1003), a decoded value (1004) corresponding to the codeword, and a control information piece (1005) specifying a lookup table depending on the decoded value and used subsequently are produced in parallel. Therefore, execution of a high-performance real time decode of variable-length codes can be conducted easily and readily.

In addition, the variable-length decoding of contents based on various coding systems can be performed easily and readily by changing stored contents of decoded values (1004) and control information pieces (1005) stored in the lookup tables.

According to a preferable embodiment, in decode of one other codeword (“1”; 1003) supplied just after the one codeword, one other decoded value (“0”; 1004) corresponding to the other codeword, and an other control information piece (“LA2”; 1005) for selecting, from the plurality of lookup tables, an other lookup table (LUT2) depending on the other decoded value and used for a next decode are produced from the next lookup table in response to the other codeword in parallel.

According to another preferable embodiment, each of the codewords is a variable length syntax element encoded according to a predetermined syntax, and the decode of a preceding syntax element and the decode of a subsequent syntax element are executed sequentially. The next lookup table (LUT2) used for the decode of the subsequent syntax element is specified by the control information piece (“LA2”; 1005) produced in parallel with the one decoded value (“1”; 1004) produced from the one lookup table (LUT3) used for the decode of the preceding syntax element.

According to a more preferable embodiment, the memory device (1001) including the plurality of lookup tables (LUT1-LUT14) is a built-in memory incorporated in a semiconductor integrated circuit (see FIG. 3).

According to a still more preferable embodiment, the built-in memory is a random access memory (1001), and the decoded value and control information piece stored in the random access memory can be transferred from a nonvolatile memory during an initialization sequence of the semiconductor integrated circuit.

According to a specific embodiment, the nonvolatile memory is one of a semiconductor nonvolatile memory incorporated in a system with the semiconductor integrated circuit incorporated therein and a built-in semiconductor nonvolatile memory with the semiconductor integrated circuit incorporated therein.

According to another specific embodiment, the codewords making the syntax element are quantization-transform coefficients produced by moving-picture variable length coding.

According to a most specific embodiment, the moving-picture variable length coding is context-adaptive variable length coding (CAVLC) of H.264/AVC, and the codewords have been encoded with syntax elements of run-before values.

In the first decode of one codeword (“10”; 1003) of the codewords of the run-before values, the one lookup table (LUT3) first selected from the plurality of lookup tables is selected according to a total zeros' number (Total zeros).

The next lookup table (LUT2) used for the decode of the subsequent syntax element is specified by a zeroLeft (zero_left) indicating the control information piece (“LA2”; 1005) produced from the one lookup table (LUT3) used for the decode of the preceding syntax element.

[2] A moving picture decoder according to a preferred embodiment viewed from another aspect of the invention includes: a bit-stream-processing unit (10); an inverse-quantization unit (11); an inverse-transform unit (12); an intra prediction unit (13); and an inter prediction unit (14).

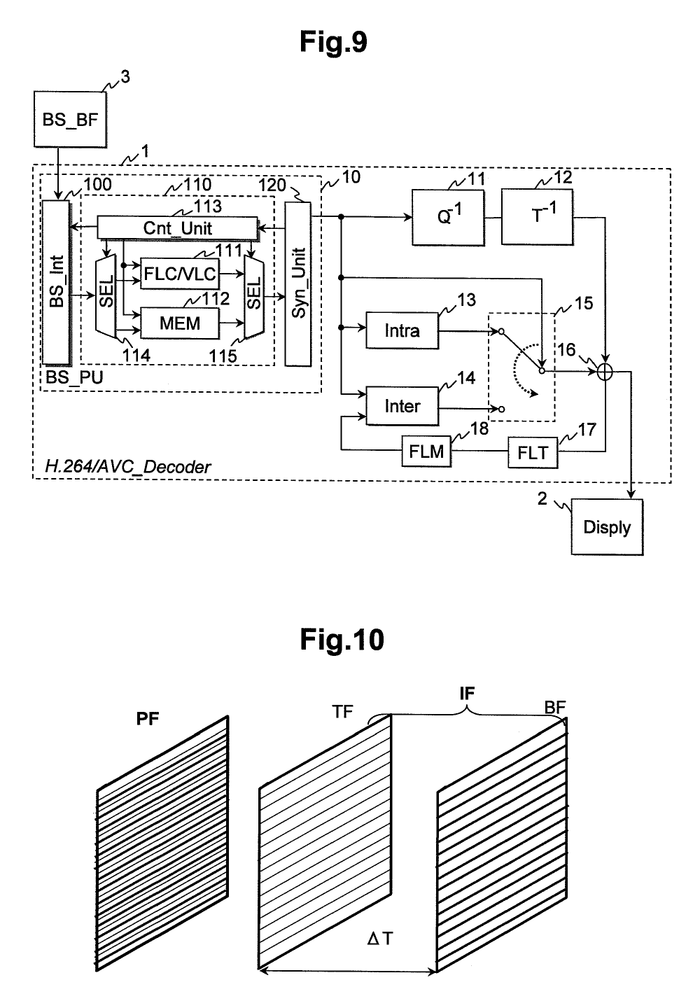

The bit-stream-processing unit produces decoded data from a bit stream of moving-picture coded data encoded according to a predetermined system. The inverse-quantization unit and inverse-transform unit execute inverse-quantization and inverse-transform of the decoded data respectively. The intra prediction unit and inter prediction unit execute intra-frame prediction and inter-frame prediction respectively (see FIG. 9).

The bit-stream-processing unit (10) includes a variable-length-code-and-decode table (112). The variable-length-code-and-decode table has a memory device (1001) including a plurality of lookup tables (LUT1-LUT14) (see FIG. 3) Codewords (1003) contained in the bit stream of the moving picture coded data can be decoded sequentially using the memory device.

Decoded values (1004) corresponding to the codewords (1003) and control information pieces (1005) can be stored in the plurality of lookup tables (see FIG. 4).

One lookup table (LUT3) is selected from among the plurality of lookup tables in decoding one codeword (“10”; 1003) of the codewords.

In the decode of the one codeword, one decoded value (“1”; 1004) corresponding to the one codeword, and a control information piece (“LA2”; 1005) for selecting, from among the plurality of lookup tables, a next lookup table (LUT2) depending on the one decoded value and used for a next decode are produced from the one lookup table in response to the one codeword in parallel.

According to the above embodiment, in decoding a codeword (1003), a decoded value (1004) corresponding to the codeword, and a control information piece (1005) specifying a lookup table depending on the decoded value and used subsequently are produced in parallel. Therefore, execution of a high-performance real time decode of variable-length codes can be conducted easily and readily.

Further, the variable-length decoding of contents based on various coding systems including H.264/AVC, MPEG-2 and MPEG-4 can be performed easily and readily by appropriately changing contents of decoded values and control information pieces stored in the lookup tables.

According to a preferable embodiment, in decode of one other codeword (“1”; 1003) supplied just after the one codeword, one other decoded value (“0”; 1004) corresponding to the other codeword, and an other control information piece (“LA2”; 1005) for selecting, from the plurality of lookup tables, an other lookup table (LUT2) depending on the other decoded value and used for a next decode are produced from the next lookup table in response to the other codeword in parallel.

According to another preferable embodiment, each of the codewords is a variable length syntax element encoded according to a predetermined syntax, and the decode of a preceding syntax element and the decode of a subsequent syntax element are executed sequentially. The next lookup table (LUT2) used for the decode of the subsequent syntax element is specified by the control information piece (“LA2”; 1005) produced in parallel with the one decoded value (“1”; 1004) produced from the one lookup table (LUT3) used for the decode of the preceding syntax element.

According to a more preferable embodiment, the memory device (1001) including the plurality of lookup tables (LUT1-LUT14) is a built-in memory incorporated in a semiconductor integrated circuit (see FIG. 3).

According to a still more preferable embodiment, the built-in memory is a random access memory (1001), and the decoded value and control information piece stored in the random access memory can be transferred from a nonvolatile memory during an initialization sequence of the semiconductor integrated circuit.

According to a specific embodiment, the nonvolatile memory is one of a semiconductor nonvolatile memory incorporated in a system with the semiconductor integrated circuit incorporated therein and a built-in semiconductor nonvolatile memory with the semiconductor integrated circuit incorporated therein.

According to another specific embodiment, the codewords making the syntax element are quantization-transform coefficients produced by moving-picture variable length coding.

According to a most specific embodiment, the moving-picture variable length coding is context-adaptive variable length coding (CAVLC) of H.264/AVC, and the codewords have been encoded with syntax elements of run-before values.

In the first decode of one codeword (“10”; 1003) of the codewords of the run-before values, the one lookup table (LUT3) first selected from the plurality of lookup tables is selected according to a total zeros' number (Total zeros).

The next lookup table (LUT2) used for the decode of the subsequent syntax element is specified by a zeroLeft (zero_left) indicating the control information piece (“LA2”; 1005) produced from the one lookup table (LUT3) used for the decode of the preceding syntax element.

### 2. Further Detailed Description of the Preferred Embodiments

Here, the preferred embodiments will be described further in detail. The best forms for carrying out the invention are described below with reference to the drawings in detail, however as to all the drawings to which reference is made in describing the best forms for carrying out the invention, the constituents or elements having identical functions are identified by the same reference numeral or character, and the repeated description thereof is omitted.

### <<Variable-Length-Decoding Device>>

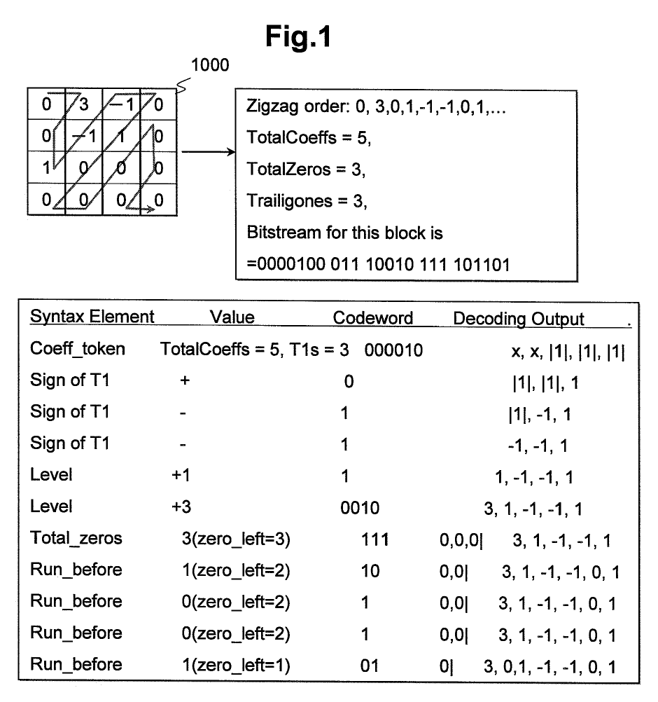

FIG. 3 is a diagram showing a structure of part of a variable-length-decoding device according to an embodiment of the invention, which is intended to execute the decode of a run-before value in connection with a quantization-transform coefficient as shown in FIG. 1 and the update of the zerosLeft for decoding the subsequent run-before value.

The structure of part of the variable-length-decoding device shown in FIG. 3 includes a memory 1001 and an access-control unit 1002, which are integrated into an LSI chip. The memory 1001 can be included in a RAM (Random Access Memory) with a built-in LSI physically. However, logically it is formed by at least 14 lookup tables LUT1, LUT2, LUT3, . . . , LUT12, LUT13 and LUT14 for decode of run-before values.

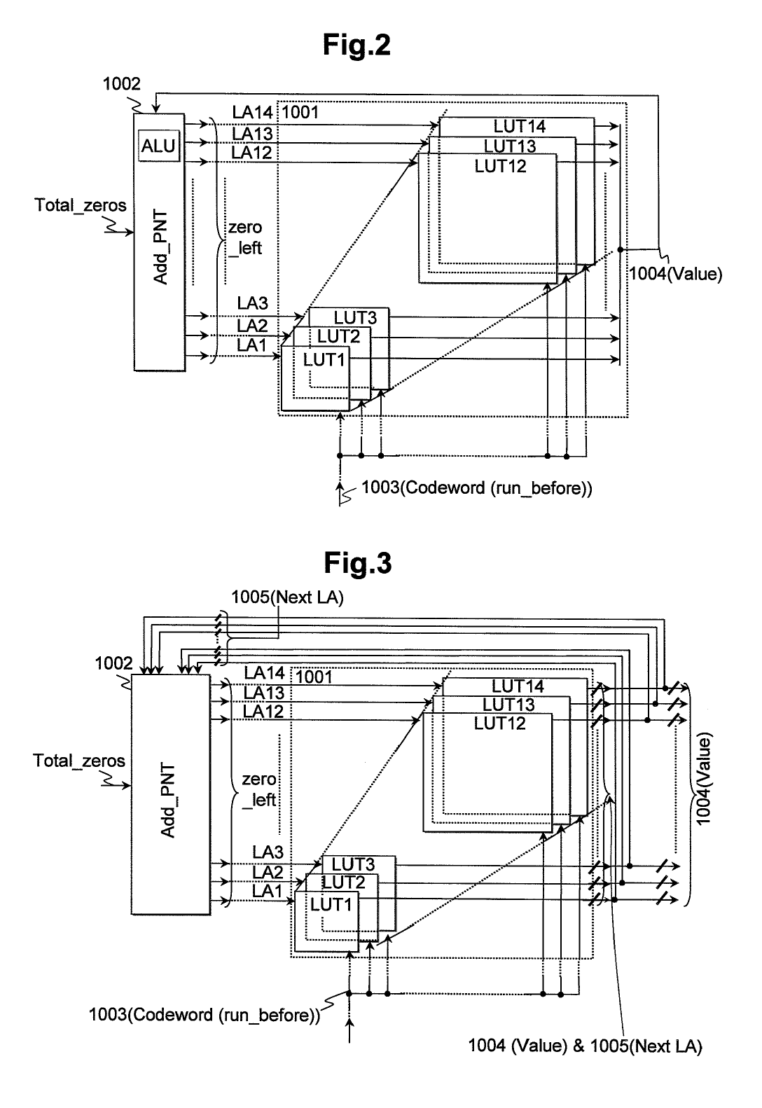

Therefore, actions performed in the variable-length-decoding device of FIG. 3 are similar to those executed in the device of FIG. 2. Specifically, the total zeros' number (Total_zeros) representing the initial value of the zerosLeft (zeros_left) is supplied to the access-control unit 1002. In case that the total zeros' number is the maximum of 14 showing 14 zeros, the access-control unit 1002 supplies the lookup table LUT14 with an initial value of the pointer address LA14 for indicating the fourteenth lookup table LUT14 in response to the value of 14, i.e. the maximum of the total zeros' number. In response to a codeword 1003 resulting from encode of a run-before value, which shows the number of zero runs just before a non-zero coefficient and takes on a value between 0 and 14, the lookup table LUT14 forms, as a result of decode, a decoded value (Value) 1004.

In parallel with the formation of the decoded value (Value) 1004, a next pointer address (LA) 1005 is formed from the lookup table LUT14 of the memory 1001 to prepare for decode of the subsequent run-before value. The value of the next pointer address (LA) 1005 is a result of a subtraction of the decoded value (Value) 1004 from the initial value of the pointer address (LA). As the number of zero runs just before a non-zero coefficient ranges between 0 and 14, the next pointer address (Next LA) 1005 is made one of the pointer addresses LA14-LA1.

The physical layout of data inside the memory 1001 included in RAM with a built-in LSI is decided so that the 14 lookup tables LUT1 to LUT14 of the memory 1001 outputs, in parallel, the decoded value 1004 and next pointer address (LA) 1005 in response to a codeword 1003 resulting from encode of a run-before value.

<<Memory Structure Including 14 Lookup Tables>>

FIG. 4 is a diagram showing a structure of the memory 1001 in the structure of part of the variable-length-decoding device shown in FIG. 3, which includes 14 lookup tables LUT1 to LUT14 for outputting, in parallel, a decoded value 1004 and next pointer address (LA) 1005 in response to a codeword 1003.

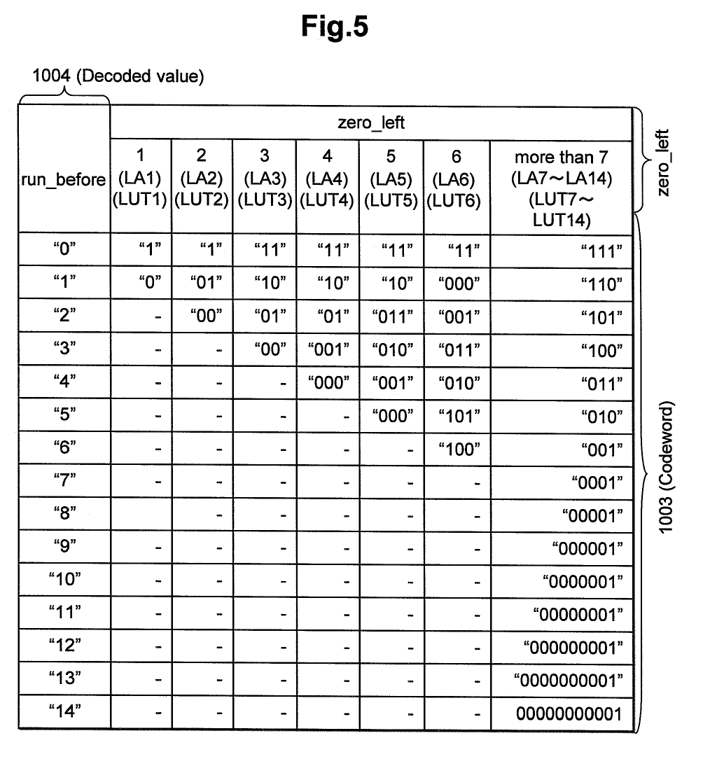

FIG. 5 is a diagram showing relations among the decoded value 1004 of a run-before value to be decoded using the structure of part of the variable-length-decoding device shown in FIG. 3, the initial value of the zerosLeft (zeros_left) before decode and the codeword (Codeword) 1003 resulting from encode of a run-before value. As shown in FIG. 5, the lookup table used to decode a run-before value is decided from among the 14 lookup tables LUT1 to LUT14 depending on the initial value of the zerosLeft before decode.

As shown in FIG. 4, the memory 1001 includes 14 memory regions specified by the 14 pointer addresses LA1-LA14 so as to create the decoded values 1004 of run-before values shown in FIG. 5.

The first memory region specified by the first pointer address LA1 contains a first entry specified by the word “1” of the codeword 1003, and a second entry specified by the word “0” of the codeword 1003. Stored in the first entry specified by the word “1” of the codeword 1003 are: a decoded value 1004 of the decoded data “0”; and a next pointer address 1005 of address data “LA1” indicating the first lookup table LUT1. Stored in the second entry specified by the word “0” of the codeword 1003 are: a decoded value 1004 of the decoded data “1”; and a next pointer address 1005 of the data “None” showing that there is no lookup table to indicate.

The second memory region specified by the second pointer address LA2 contains a first entry specified by the word “1” of the codeword 1003, a second entry specified by the word “01” of the codeword 1003, and a third entry specified by the word “00” of the codeword 1003. Stored in the first entry specified by the word “1” of the codeword 1003 are: a decoded value 1004 of the decoded data “0”; and a next pointer address 1005 of the address data “LA2” indicating the second lookup table LUT2. Stored in the second entry specified by the word “01” of the codeword 1003 are: a decoded value 1004 of the decoded data “1”; and a next pointer address 1005 of the address data “LA1” indicating the first lookup table LUT1. Stored in the third entry specified by the word “00” of the codeword 1003 are: a decoded value 1004 of the decoded data “2”; and a next pointer address 1005 of the data “None” showing that there is no lookup table to indicate.

The third memory region specified by the third pointer address LA3 contains a first entry specified by the word “11” of the codeword 1003, a second entry specified by the word “10” of the codeword 1003, a third entry specified by the word “01” of the codeword 1003, and a fourth entry specified by the word “00” of the codeword 1003. Stored in the first entry specified by the word “11” of the codeword 1003 are: a decoded value 1004 of the decoded data “0”; and a next pointer address 1005 of the address data “LA3” indicating the third lookup table LUT3. Stored in the second entry specified by the word “10” of the codeword 1003 are: a decoded value 1004 of the decoded data “1”; and a next pointer address 1005 of the address data “LA2” indicating the second lookup table LUT2. Stored in the third entry specified by the word “01” of the codeword 1003 are: a decoded value 1004 of the decoded data “2”; and a next pointer address 1005 of the address data “LA1” indicating the first lookup table LUT1. Stored in the fourth entry specified by the word “00” of the codeword 1003 are: a decoded value 1004 of the decoded data “3”; and a next pointer address 1005 of the data “None” showing that there is no lookup table to indicate.

The fourth memory region specified by the fourth pointer address LA4 to the fourteenth memory region specified by the fourteenth pointer address LA14 are arranged in the same way as described above.

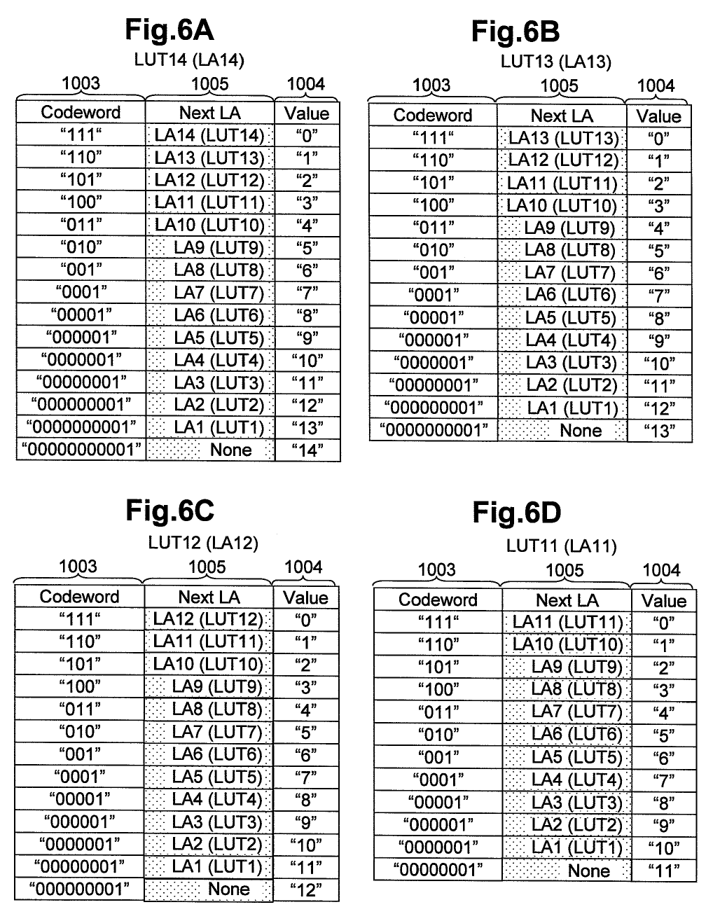

FIGS. 6A-6D are diagrams showing structures of the fourteenth to eleventh memory regions in the memory 1001 of FIG. 4, which are specified by the fourteenth to eleventh pointer addresses respectively.

As shown in FIG. 6A, the fourteenth memory region specified by the fourteenth pointer address LA14 contains a first entry specified by the word “111” of the codeword 1003 to a fifteenth entry specified by the word “00000000001” of the codeword 1003. Stored in the first entry specified by the word “111” of the codeword 1003 are: a decoded value 1004 of the decoded data “0”; and a next pointer address 1005 of the address data “LA14” indicating the fourteenth lookup table LUT14. Stored in the second entry specified by the word “110” of the codeword 1003 are: a decoded value 1004 of decoded data “1”; and a next pointer address 1005 of the address data “LA13” indicating the thirteenth lookup table LUT13. Stored in the fifteenth entry specified by the word “00000000001” of the codeword 1003 are: a decoded value 1004 of the decoded data “14”; and a next pointer address 1005 of the data “None” showing that there is no lookup table to indicate.

As shown in FIG. 6B, the thirteenth memory region specified by the thirteenth pointer address LA13 contains a first entry specified by the word “111” of the codeword 1003 to a fourteenth entry specified by the word “0000000001” of the codeword 1003. Stored in the first entry specified by the word “111” of the codeword 1003 are: a decoded value 1004 of the decoded data “0”; and a next pointer address 1005 of the address data “LA13” indicating the thirteenth lookup table LUT13. Stored in the second entry specified by the word “110” of the codeword 1003 are: a decoded value 1004 of the decoded data “1”; and a next pointer address 1005 of the address data “LA12” indicating the twelfth lookup table LUT12. Stored in the fourteenth entry specified by the word “0000000001” of the codeword 1003 are: a decoded value 1004 of the decoded data “13”; and a next pointer address 1005 of the data “None” showing that there is no lookup table to indicate.

As shown in FIG. 6C, the twelfth memory region specified by the twelfth pointer address LA12 contains a first entry specified by the word “111” of the codeword 1003 to a thirteenth entry specified by the word “000000001” of the codeword 1003. Stored in the first entry specified by the word “111” of the codeword 1003 are: a decoded value 1004 of the decoded data “0”; and a next pointer address 1005 of the address data “LA12” indicating the twelfth lookup table LUT12. Stored in the second entry specified by the word “110” of the codeword 1003 are: a decoded value 1004 of the decoded data “1”; and a next pointer address 1005 of the address data “LA11” indicating the eleventh lookup table LUT11. Stored in the thirteenth entry specified by the word “000000001” of the codeword 1003 are: a decoded value 1004 of the decoded data “12”; and a next pointer address 1005 of the data “None” showing that there is no lookup table to indicate.

As shown in FIG. 6D, the eleventh memory region specified by the eleventh pointer address LA11 contains a first entry specified by the word “111” of the codeword 1003 to a twelfth entry specified by the word “00000001” of the codeword 1003. Stored in the first entry specified by the word “111” of the codeword 1003 are: a decoded value 1004 of the decoded data “0”; and a next pointer address 1005 of the address data “LA11” indicating the eleventh lookup table LUT11. Stored in the second entry specified by the word “110” of the codeword 1003 are: a decoded value 1004 of the decoded data “1”; and a next pointer address 1005 of the address data “LA10” indicating the tenth lookup table LUT10. Stored in the twelfth entry specified by the word “00000001” of the codeword 1003 are: a decoded value 1004 of the decoded data “11”; and a next pointer address 1005 of the data “None” showing that there is no lookup table to indicate.

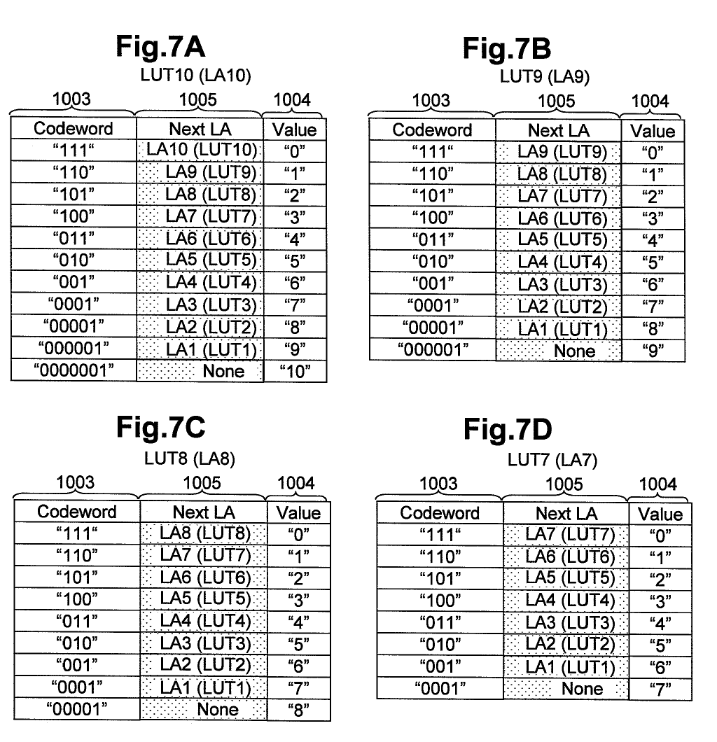

FIGS. 7A-7D are diagrams showing structures of the tenth to seventh memory regions in the memory 1001 of FIG. 4, which are specified the tenth to seventh pointer addresses respectively.

As shown in FIG. 7A, the tenth memory region specified by the tenth pointer address LA10 contains a first entry specified by the word “111” of the codeword 1003 to an eleventh entry specified by the word “0000001” of the codeword 1003. Stored in the first entry specified by the word “111” of the codeword 1003 are: a decoded value 1004 of the decoded data “0”; and a next pointer address 1005 of the address data “LA10” indicating the tenth lookup table LUT10. Stored in the second entry specified by the word “110” of the codeword 1003 are: a decoded value 1004 of the decoded data “1”; and a next pointer address 1005 of the address data “LA9” indicating the ninth lookup table LUT9. Stored in the eleventh entry specified by the word “0000001” of the codeword 1003 are: a decoded value 1004 of the decoded data “10”; and a next pointer address 1005 of the data “None” showing that there is no lookup table to indicate.

As shown in FIG. 7B, the ninth memory region specified by the ninth pointer address LA9 contains a first entry specified by the word “111” of the codeword 1003 to a tenth entry specified by the word “000001” of the codeword 1003. Stored in the first entry specified by the word “111” of the codeword 1003 are: a decoded value 1004 of the decoded data “0”; and a next pointer address 1005 of the address data “LA9” indicating the ninth lookup table LUT9. Stored in the second entry specified by the word “110” of the codeword 1003 are: a decoded value 1004 of the decoded data “1”; and a next pointer address 1005 of the address data “LA8” indicating the eighth lookup table LUT8. Stored in the tenth entry specified by the word “000001” of the codeword 1003 are: a decoded value 1004 of the decoded data “9”; and a next pointer address 1005 of the data “None” showing that there is no lookup table to indicate.

As shown in FIG. 7C, the eighth memory region specified by the eighth pointer address LA8 contains a first entry specified by the word “111” of the codeword 1003 to a ninth entry specified by the word “00001” of the codeword 1003 Stored in the first entry specified by the word “111” of the codeword 1003 are: a decoded value 1004 of the decoded data “0”; and a next pointer address 1005 of the address data “LA8” indicating the eighth lookup table LUT8. Stored in the second entry specified by the word “110” of the codeword 1003 are: a decoded value 1004 of the decoded data “1”; and a next pointer address 1005 of the address data “LA7” indicating the seventh lookup table LUT11. Stored in the ninth entry specified by the word “00001” of the codeword 1003 are: a decoded value 1004 of the decoded data “8”; and a next pointer address 1005 of the data “None” showing that there is no lookup table to indicate.

As shown in FIG. 7D, the seventh memory region specified by the seventh pointer address LA7 contains a first entry specified by the word “111” of the codeword 1003 to an eighth entry specified by the word “001” of the codeword 1003. Stored in the first entry specified by the word “111” of the codeword 1003 are: a decoded value 1004 of the decoded data “0”; and a next pointer address 1005 of the address data “LA7” indicating the seventh lookup table LUT 7. Stored in the second entry specified by the word “110” of the codeword 1003 are: a decoded value 1004 of the decoded data “1”; and a next pointer address 1005 of the address data “LA6” indicating the sixth lookup table LUT6. Stored in the eighth entry specified by the word “001” of the codeword 1003 are: a decoded value 1004 of the decoded data “7”; and a next pointer address 1005 of the data “None” showing that there is no lookup table to indicate.

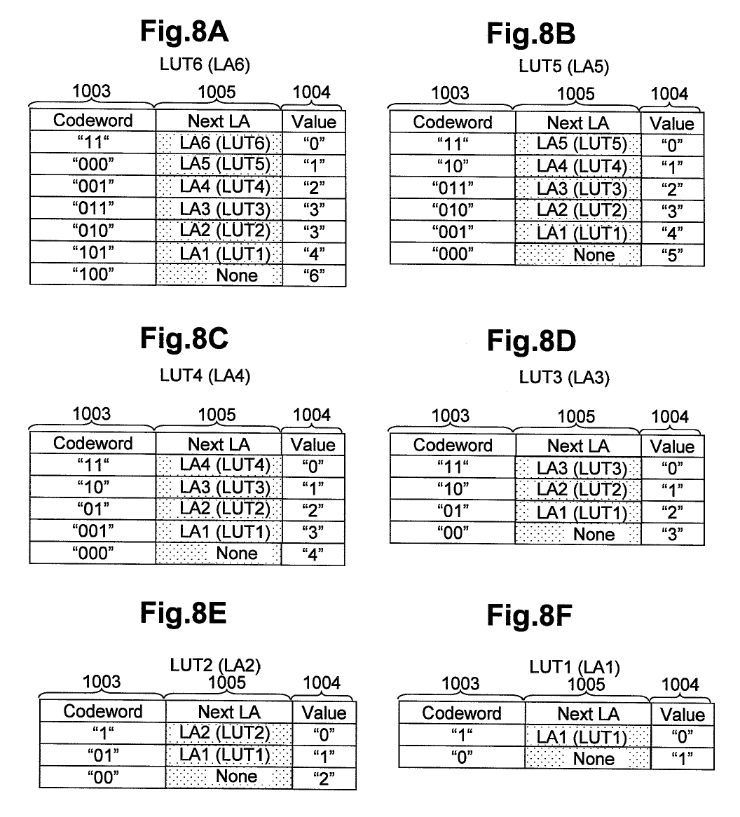

FIGS. 8A-8F are diagrams showing structures of the sixth to first memory regions in the memory 1001 of FIG. 4, which are specified by the sixth to first pointer addresses respectively.

As shown in FIG. 8A, the sixth memory region specified by the sixth pointer address LA6 contains a first entry specified by the word “11” of the codeword 1003 to a seventh entry specified by the word “100” of the codeword 1003. Stored in the first entry specified by the word “11” of the codeword 1003 are: a decoded value 1004 of the decoded data “0”; and a next pointer address 1005 of the address data “LA6” specified by the sixth lookup table LUT6. Stored in the second entry specified by the word “000” of the codeword 1003 are: a decoded value 1004 of the decoded data “1”; and a next pointer address 1005 of the address data “LA5” indicating the fifth lookup table LUT5. Stored in the seventh entry specified by the word “100” of the codeword 1003 are: a decoded value 1004 of the decoded data “6”; and a next pointer address 1005 of the data “None” showing that there is no lookup table to indicate.

As shown in FIG. 8B, the fifth memory region specified by the fifth pointer address LA5 contains a first entry specified by the word “11” of the codeword 1003 to a sixth entry specified by the word “000” of the codeword 1003. Stored in the first entry specified by the word “11” of the codeword 1003 are: a decoded value 1004 of the decoded data “0”; and a next pointer address 1005 of the address data “LA5” indicating the fifth lookup table LUT5. Stored in the second entry specified by the word “10” of the codeword 1003 are: a decoded value 1004 of the decoded data “1”; and a next pointer address 1005 of the address data “LA4” indicating the fourth lookup table LUT4. Stored in the sixth entry specified by the word “000” of the codeword 1003 are: a decoded value 1004 of the decoded data “5”; and a next pointer address 1005 of the data “None” showing that there is no lookup table to indicate.

As shown in FIG. 8C, the fourth memory region specified by the fourth pointer address LA4 contains a first entry specified by the word “11” of the codeword 1003 to a fifth entry specified by the word “000” of the codeword 1003. Stored in the first entry specified by the word “11” of the codeword 1003 are: a decoded value 1004 of the decoded data “0”; and a next pointer address 1005 of the address data “LA4” indicating the fourth lookup table LUT4. Stored in the second entry specified by the word “10” of the codeword 1003 are: a decoded value 1004 of the decoded data “1”; and a next pointer address 1005 of the address data “LA3” indicating the third lookup table LUT3. Stored in the fifth entry specified by the word “000” of the codeword 1003 are: a decoded value 1004 of the decoded data “4”; and a next pointer address 1005 of the data “None” showing that there is no lookup table to indicate.

As shown in FIG. 8D, the third memory region specified by the third pointer address LA3 contains a first entry specified by the word “11” of the codeword 1003 to a fourth entry specified by the word “00” of the codeword 1003. Stored in the first entry specified by the word “11” of the codeword 1003 are: a decoded value 1004 of the decoded data “0”; and a next pointer address 1005 of the address data “LA3” indicating the third lookup table LUT3. Stored in the second entry specified by the word “10” of the codeword 1003 are: a decoded value 1004 of the decoded data “1”; and a next pointer address 1005 of the address data “LA2” indicating the second lookup table LUT2. Stored in the third entry specified by the word “01” of the codeword 1003 are: a decoded value 1004 of the decoded data “2”; and a next pointer address 1005 of the address data “LA1” indicating the first lookup table LUT1. Stored in the fourth entry specified by the word “00” of the codeword 1003 are: a decoded value 1004 of the decoded data “3”; and a next pointer address 1005 of the data “None” showing that there is no lookup table to indicate.

As shown in FIG. 8E, the second memory region specified by the second pointer address LA2 contains a first entry specified by the word “1” of the codeword 1003 to a third entry specified by the word “00” of the codeword 1003. Stored in the first entry specified by the word “1” of the codeword 1003 are: a decoded value 1004 of the decoded data “0”; and a next pointer address 1005 of the address data “LA2” indicating the second lookup table LUT2. Stored in the second entry specified by the word “01” of the codeword 1003 are: a decoded value 1004 of the decoded data “1”; and a next pointer address 1005 of the address data “LA1” indicating the first lookup table LUT1. Stored in the third entry specified by the word “00” of the codeword 1003 are: a decoded value 1004 of the decoded data “2”; and a next pointer address 1005 of the data “None” showing that there is no lookup table to indicate.

As shown in FIG. 8F, the first memory region specified by the first pointer address LA1 contains a first entry specified by the word “1” of the codeword 1003 to a second entry specified by the word “0” of the codeword 1003. Stored in the first entry specified by the word “1” of the codeword 1003 are: a decoded value 1004 of the decoded data “0”; and a next pointer address 1005 of the address data “LA1” indicating the first lookup table LUT1. Stored in the second entry specified by the word “0” of the codeword 1003 are: a decoded value 1004 of the decoded data “1”; and a next pointer address 1005 of the data “None” showing that there is no lookup table to indicate.

<<Decode of Run-Before Values>>

Now, how the variable-length-decoding device shown in FIG. 3 when decoding runs-before values (runs_before) in connection with the quantization-transform coefficients shown in FIG. 1 operates will be described. The decoding device has the memory 1001 including the 14 lookup tables LUT1 to LUT14, which has been described with reference to FIGS. 4 and 6-8.

Now, reference is made to the example of FIG. 1 again. After the total zeros' number (Total zeros) of 3 have been decoded, the zeroLeft (zero_left), which has not been decoded, is used at time of decoding the first runs-before value (runs_before) based on the total zeros' number thus decoded. The initial value of the zerosLeft is the total zeros' number.

In the example of FIG. 1, in the step of decoding the first runs-before value (runs_before) after the total zeros' number (Total zeros), the third lookup table LUT3 specified by the pointer address LA3 corresponding to the zerosLeft (zero_left) of 3 is used. In the example of FIG. 1, in the step of decoding the first runs-before value (runs_before) after Total zeros, a decoded value of the decoded data “1” and the second pointer address LA2 indicating the second lookup table LUT2 are produced in parallel based on the third lookup table LUT3 in response to the codeword 1003 of the word “10”.

Further, in the example of FIG. 1, in the step of decoding the second runs-before value (runs_before) after Total zeros, the second lookup table LUT2 indicated by the second pointer address LA2 is used. In the step of decoding the second runs-before value in the example of FIG. 1, a decoded value of the decoded data “0” and the second pointer address LA2 indicating the second lookup table LUT2 are produced in parallel based on the second lookup table LUT2 in response to a codeword 1003 of the word “1”.

Still further, in the example of FIG. 1, in the step of decoding the third runs-before value (runs_before) after Total zeros, the second lookup table LUT2 indicated by the second pointer address LA2 is used. In the step of decoding the third runs-before value in the example of FIG. 1, a decoded value of the decoded data “0” and the second pointer address LA2 indicating the second lookup table LUT2 are produced in parallel based on the second lookup table LUT2 in response to a codeword 1003 of the word “1”.

Furthermore, in the example of FIG. 1, in the step of decoding the fourth runs-before value (runs_before) after Total zeros, the second lookup table LUT2 indicated by the second pointer address LA2 is used. In the step of decoding the third runs-before value in the example of FIG. 1, a decoded value of the decoded data “1” and the first pointer address LA1 indicating the first lookup table LUT1 are produced in parallel based on the second lookup table LUT2 in response to a codeword 1003 of the word “01”.

<<Specific Form of the Variable-Length-Decoding Device>>

FIG. 9 is a diagram showing a structure of a moving-picture-decoding device (decoder) compliant with H.264/AVC according to a specific embodiment of the invention.

The moving-picture-decoding device 1 of FIG. 9 can apply to moving-picture-decoding devices for picture-encoding systems including MPEG-2 and MPEG-4 other than H.264/AVC.

The moving-picture-decoding device 1 is formed on an LSI chip of a moving-picture processing semiconductor IC for battery-driven portable electronic devices including a mobile phone terminal and a digital camera. In the form of FIG. 9, during a system-initialization sequence e.g. at time of power-on or power-on reset of an electronic device, the semiconductor IC is supplied with an operation mode signal with a level or bit pattern for directing that the IC work as a moving-picture encoding device (i.e. an encoder) or a moving-picture-decoding device (i.e. a decoder). As a result, in response to the direction by the operation mode signal, a common hardware resource constituting the moving-picture processing semiconductor IC serves as one of a moving-picture encoding device (encoder) and a moving-picture-decoding device (decoder). Further, on receipt of supply of an operation mode signal with another level or bit pattern during the system-initialization sequence, the common hardware resource constituting the moving-picture processing semiconductor IC operates as the other of a moving-picture encoding device (encoder) and a moving-picture-decoding device (decoder).

In case that the moving-picture processing semiconductor IC serves as a moving-picture-decoding device (decoder), moving-picture coded data compliant with H.264/AVC are supplied in a bit stream form from a medium, e.g. an HDD (Hard Disc Drive), an optical disc drive, a large-capacity nonvolatile flash memory and wireless LAN (Local Area Network). The moving-picture coded data are decoded by the moving-picture-decoding device (decoder), and the resultant decoded data are stored in a memory device for display, whereby a moving picture can be displayed by a display device 2.

In case that the moving-picture processing semiconductor IC serves as a moving-picture encoding device (encoder), moving-picture data are supplied from an image-pickup device, e.g. a CCD or a CMOS image sensor. Video coded data compliant with H.264/AVC obtained as outputs from the moving-picture encoding device (encoder) can be stored in a memory device, such as an HDD, an optical disc or a large-capacity nonvolatile flash memory.

As in FIG. 9, bit streams of moving-picture coded data compliant with H.264/AVC are supplied to the bit stream buffer 3 from various types of media as described above, and are stored therein. The bit-stream-processing unit 10 is a block for performing a process of analyzing, in syntax, bit streams input from the outside, and a process of decoding variable-length codes.

The inverse-quantization unit 11 and inverse-transform unit 12 are a block which performs the inverse-quantization of decoded data from the bit-stream-processing unit 10, and a block which performs inverse-transform thereof, respectively. An output from the inverse-transform unit 12 is supplied to one input terminal of the adder 16. The inverse-transform in the inverse-transform unit 12 is IDCT (Inverse Discrete Cosine Transform) defined by Codec standards.

The intra prediction unit 13 executes an intra-frame prediction (in-screen prediction) compliant with H.264/AVC while the inter prediction unit 14 conducts an inter-frame prediction (inter-screen prediction). An output from the intra prediction unit 13 and an output from the inter prediction unit 14 are selected by the select switch 15. The output selected by the select switch 15 is supplied to the other input terminal of the adder 16. An output from the adder 16 is provided to the inter prediction unit 14 through a filter 17 and a frame memory 18, and in parallel, supplied to a display device 2 outside the moving-picture-decoding device 1.

The bit-stream-processing unit 10 includes a stream interface unit 100, a codeword-processing unit 110, and a syntax-processing unit 120. A bit stream from the outside is supplied to the codeword-processing unit 110 through the stream interface unit 100. The codeword-processing unit 110 decodes various codewords contained in the bit stream. A decoded value (Value) formed as a result of decode by the codeword-processing unit 110 is supplied to the syntax-processing unit 120. The syntax-processing unit 120 produces a result of decode from the decoded value thus supplied.

The codeword-processing unit 110 includes an FLC/VLC processing unit 111, a variable-length-code-and-decode table 112, a processing-control unit 113, an input selector 114 and an output selector 115. The FLC/VLC processing unit 111 is a processing unit which decodes an FLC (Fixed Length code), and decodes a VLC (Variable Length Code) for executing a decode by an arithmetic operation like decode of an exponential Golomb code. The variable-length-code-and-decode table 112 is a memory for decode of a variable-length code, which needs to make a reference to a lookup table, and includes lookup tables containing decoded values (Value) corresponding to variable-length codewords defined by Codec standards of the moving-picture-decoding device 1 of FIG. 9.

Particularly, in this embodiment of the invention, each lookup table of the variable-length-code-and-decode table 112 outputs a decoded value in response to a variable-length codeword, and outputs a pointer address indicating a lookup table used for decode of the subsequent codeword. Specifically, the variable-length-code-and-decode table 112 is composed of a RAM 1001 with a built-in LSI, which includes at least 14 lookup tables LUT1 to LUT14 each operable to output a decoded word 1004 and a next pointer address 1005 in parallel in response to a codeword 1003 as shown in FIGS. 3 and 4.

With CAVLC (Context-Adaptive Variable Length Coding) adopted by H.264/AVC, the first bit position of the subsequent syntax element is decided at the completion of decode of a syntax element currently in course of processing. Therefore, the processing-control unit 113 controls the stream interface unit 100, input selector 114 and output selector 115 in response to a result of decode produced by the syntax-processing unit 120. Consequently, the subsequent syntax element from the bit stream buffer 3 is supplied to the FLC/VLC processing unit 111 or variable-length-code-and-decode table 112 through the stream interface unit 100 and input selector 114, and then a codeword of the syntax element is decoded. On completion of decode of the syntax element, a decoded value (Value) is supplied from the FLC/VLC processing unit 111 or variable-length-code-and-decode table 112 to the syntax-processing unit 120 through the output selector 115.

Now, various moving-picture coding systems that a decode can be conducted by the moving-picture-decoding device 1 (decoder) compliant with H.264/AVC according to the specific embodiment of the invention shown in FIG. 9 will be described.

<<Coding Video Sequence on H.264/AVC>>

HDTV includes a large screen with a maximum of 1920 pixels in a horizontal direction and a maximum of 1080 scanning lines in a vertical direction, and has two scanning modes: an interlace scan using alternate scanning lines; and a progressive scan using successive scanning lines. A coded video sequence of a H.264/AVC video coding layer supports an interlaced frame and a progressive frame.

FIG. 10 is a diagram showing a progressive frame PF and an interlaced frame IF, which are decided by a coded video sequence of VCL (Video Coding Layer) of H.264/AVC. with an interlaced frame IF, a top field TF including even-numbered lines and a bottom field BF including odd-numbered lines are individually encoded at different times as shown in FIG. 10.

<<Intra-Frame Prediction on H.264/AVC>>

First, an intra-frame prediction by the intra prediction unit 13 of the moving-picture-decoding device 1 compliant with H.264/AVC shown in FIG. 9 will be described.

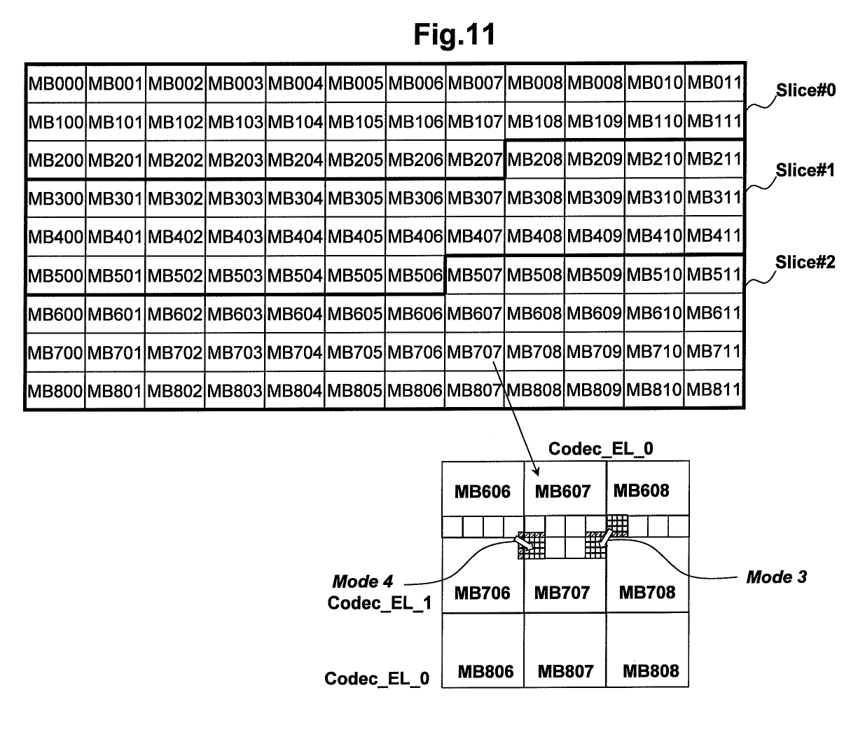

FIG. 11 is a diagram showing a slice of a picture compliant with H.264/AVC, a partition into macroblocks, and an intra-frame prediction. As shown in FIG. 11, a picture is divided into e.g. a plurality of slices Slice#0, Slice#l and Slice#2, and the slice Slice#0 is further partitioned into 32 macroblocks MB000 to MBS207. All of macroblocks MB000 to MB811 of one picture each include a quadrangular picture region of 16×16 samples in terms of luma components and a region of 8×8 samples for each of two chroma components corresponding to it.

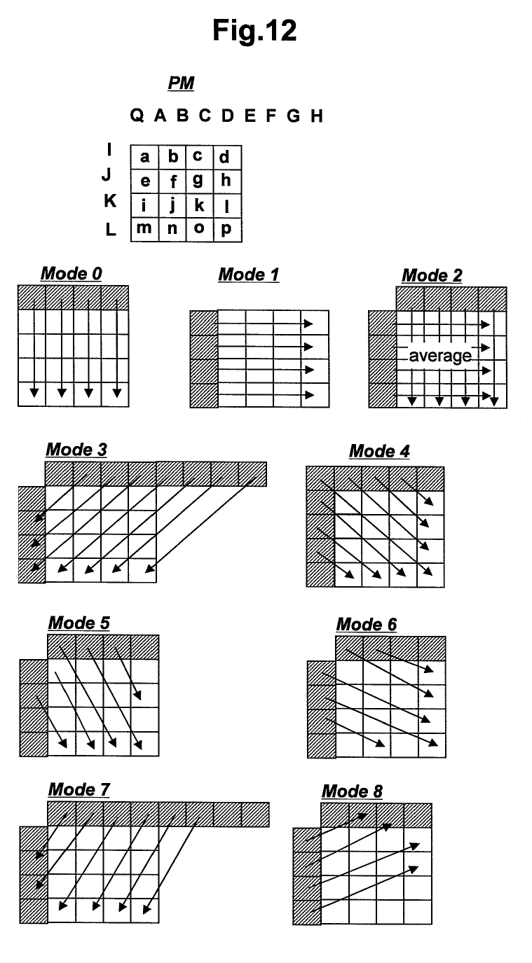

FIG. 12 is a diagram showing the way a block of 4×4 samples is predicted from a sample located spatially near to the block in a prediction mode PM in connection with intra-frame prediction compliant with H.264/AVC. Sixteen samples consisting of 4×4 blocks and denoted by characters “a” to “p” as shown in FIG. 12 can be predicted using, of neighboring blocks labeled with characters “A” to “Q”, samples which as been decoded previously. Further, the prediction mode PM includes nine 4×4 prediction modes as shown in FIG. 12. In Mode 0 (Vertical prediction), a prediction is made based on values copied in directions indicated by arrows from samples consisting of top blocks of 4×4 blocks. In Mode 1 (Horizontal prediction), a prediction is made based on values copied in directions indicated by arrows from samples consisting of leftmost blocks of 4×4 blocks. In Mode 2 (DC prediction), a prediction is made based on average values of significant pixels of top and leftmost blocks of 4×4 blocks. In Mode 3 (Oblique lower-left prediction), a prediction is made in slanting directions from top-right samples as indicated by arrows. In Mode 4 (Oblique lower-right prediction), a prediction is made in slanting directions from upper-left samples as indicated by arrows. In Mode 5 (Vertically lower right prediction), a prediction is made in slanting directions from upper-left samples as indicated by arrows. In Mode 6 (Horizontally lower right prediction), a prediction is made in slanting directions from upper-left samples as indicated by arrows. In Mode 7 (Vertically lower left prediction), a prediction is made in slanting directions from upper-right samples as indicated by arrows. In Mode 8 (Horizontally upper right prediction), a prediction is made in slanting directions from lower-left samples as indicated by arrows.

The high-performance real time decode of run-before values, which has been described with reference to FIGS. 3 and 9, can be applied to predictions concerning neighboring samples of quantization-transform coefficients (16 DCT coefficients) of the luma 4×4 blocks shown in FIG. 12.

<<Inter-Frame Prediction on H.264/AVC>>

Next, an inter-frame prediction by the inter prediction unit 12 of the moving-picture-decoding device 1 compliant with H.264/AVC shown in FIG. 9 will be described.

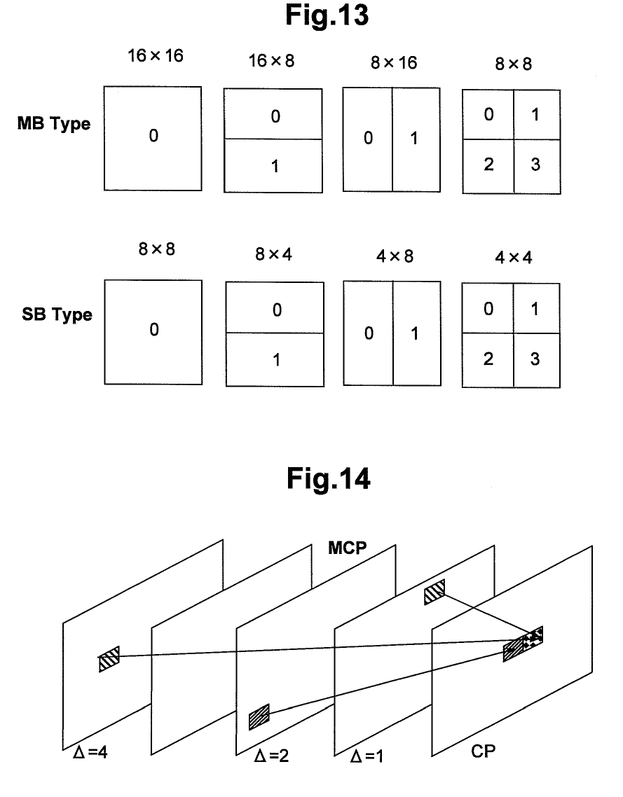

FIG. 13 is a diagram showing that one macroblock is further divided into smaller regions for a motion-compensated prediction compliant with H.264/AVC at the time when the inter prediction unit 112 performs an inter-frame prediction. The upper half portion of FIG. 13 shows partitionings with block sizes of 16×16, 16×8, 8×16 and 8×8 samples in terms of luma. The lower half portion of FIG. 13 shows partitionings with block sizes of 8×8, 8×4, 4'8 and 4×4 samples in terms of luma. The blocks for motion-compensated prediction in the upper and lower half portions of FIG. 13 each include a syntax for motion-compensated prediction. Use of the syntax enables a multipicture motion-compensated prediction, in which at least one previously encoded picture is used for reference for a motion-compensated prediction.

FIG. 14 is a diagram showing a H.264/AVC multipicture motion-compensated prediction. A current picture CP can be predicted by transmitting a motion vector and a picture-reference parameter Δ (=1, 2 or 4) from a picture which has been encoded previously.

<<Support of Other Moving-Picture Coding Systems>>

The variable-length-decoding device 1 shown in FIG. 3 or 9, which has the memory 1001 including 14 lookup tables LUT1 to LUT14 shown in FIGS. 4, 6A-6D to BA-8F, serves to decode runs-before value (runs_before) in connection with the quantization-transform coefficients compliant with H.264/AVC shown in FIG. 1.

Therefore, for the purpose of arranging the variable-length-decoding device 1 or moving-picture-decoding device 1 shown in FIG. 3 or 9 to support other moving-picture coding systems, e.g. MPEG-2 and MPEG-4, different from the H.264/AVC moving-picture coding system, it is sufficient to change memory contents stored in the memory 1001 of the variable-length-decoding device 1 of FIG. 3 and the variable-length-code-and-decode table 112 constituted by the built-in RAM of the variable-length-decoding device 1 of FIG. 9. For that purpose, data codes of a codeword 1003, decoded value (Value) i.e. result of decode, and next pointer address (LA) 1005, which make memory contents of the memory 1001 and built-in RAM of the variable-length-code-and-decode table 112 are changed so as to cope with other moving-picture coding systems, such as MPEG-2 and MPEG-4.

Data codes, which make memory contents stored in the memory 1001 or built-in RAM forming the variable-length-code-and-decode table 112 of the decoding device 1 shown in FIG. 3 or 9, can be transferred from a semiconductor nonvolatile flash memory mounted on a moving-picture decoding device, which is a system with the variable-length-decoding device 1 incorporated therein at time of system reset, such as power-on. During an initialization sequence at time of system reset, which moving-picture coding system the moving-picture decoding device be arranged to support will be selected from among H.264/AVC, MPEG-2 and MPEG-4. According to the selected system, memory contents stored in the memory 1001 or the built-in RAM forming the variable-length-code-and-decode table 112 of the variable-length-decoding device 1 are decided, and the operation system of the moving-picture decoding device which starts working after power-on can be decided.

While the invention made by the inventor has been described above specifically based on the embodiments, it is not so limited. It is needless to say that various changes and modifications may be made without departing from the subject matter thereof.

For example, a case that processing is performed on an individual macroblock (16×16 pixels) basis has been described. However, the invention is also applicable to cases that processing is conducted in macroblocks having an appropriate size, e.g. 32×32 pixels or 8×8 pixels.

Even in application to a moving-picture coding system using only in-screen coding, in which still pictures of MotionJPEG or the like are coupled to make a moving picture, the invention can achieve the same effect by making an inter-frame prediction, estimating an amount of motion and incorporating it in a quantization parameter.

In addition to a moving-picture processing semiconductor IC, the invention can be adopted extensively for an IC which executes the encode and decode of a moving picture compliant with H.264/AVC, and which is incorporated in a mixed signal system LSI having analog and digital functional blocks mixedly provided therein.

Further, the nonvolatile memory for storing memory contents transferred to the memory 1001 or the built-in RAM making the variable-length-code-and-decode table 112 of the variable-length-decoding device 1 shown in FIG. 3 or 9 during an initial sequence at time of system reset, such as power-on may be composed of a built-in nonvolatile memory incorporated in a system LSI.

What is claimed is:

1. A variable length decoder, comprising: a memory device including a plurality of lookup tables,
wherein codewords encoded by variable-length codes can be decoded sequentially using the memory device,
decoded values corresponding to the codewords and control information pieces can be stored in the plurality of lookup tables,
one lookup table is selected from among the plurality of lookup tables in decoding one of the codewords, and
in the decode of the one codeword, one decoded value corresponding to the one codeword, and a control information piece for selecting, from among the plurality of lookup tables, a next lookup table depending on the one decoded value and used for a next decode are produced from the one lookup table in response to the one codeword in parallel.

2. The variable length decoder according to claim 1, wherein in decode of one other codeword supplied just after the one codeword, one other decoded value corresponding to the other codeword, and an other control information piece for selecting, from the plurality of lookup tables, an other lookup table depending on the other decoded value and used for a next decode are produced from the next lookup table in response to the other codeword in parallel.

3. The variable length decoder according to claim 2, wherein each of the codewords is a variable length syntax element encoded according to a predetermined syntax,
decode of a preceding syntax element and decode of a subsequent syntax element are executed sequentially, and
the next lookup table used for the decode of the subsequent syntax element is specified by the control information piece produced in parallel with the one decoded value produced from the one lookup table used for the decode of the preceding syntax element.

4. The variable length decoder according to claim 3, wherein the memory device including the plurality of lookup tables is a built-in memory incorporated in a semiconductor integrated circuit.

5. The variable length decoder according to claim 4, wherein the built-in memory is a random access memory, and
the decoded value and control information piece stored in the random access memory can be transferred from a nonvolatile memory during an initialization sequence of the semiconductor integrated circuit.

6. The variable length decoder according to claim 5, wherein the nonvolatile memory is one of a semiconductor nonvolatile memory incorporated in a system with the semiconductor integrated circuit incorporated therein and a built-in semiconductor nonvolatile memory with the semiconductor integrated circuit incorporated therein.

7. The variable length decoder according to claim 2, wherein the codewords making the syntax element are quantization-transform coefficients produced by moving-picture variable length coding.

8. The variable length decoder according to claim 7, wherein the moving-picture variable length coding is context-adaptive variable length coding of H.264/AVC,
the codewords have been encoded with syntax elements of run-before values,
in the first decode of one of the codewords of the run-before values, the one lookup table first selected from the plurality of lookup tables is selected according to a total zeros' number, and
the next lookup table used for the decode of the subsequent syntax element is specified by a zeroLeft indicating the control information piece produced from the one lookup table used for the decode of the preceding syntax element.

9. A moving-picture decoder, comprising:
a bit-stream-processing unit;
an inverse-quantization unit;
an inverse-transform unit;
an intra prediction unit; and
an inter prediction unit,
wherein the bit-stream-processing unit produces decoded data from a bit stream of moving picture coded data encoded according to a predetermined system,
the inverse-quantization unit and inverse-transform unit execute inverse-quantization and inverse-transform of the decoded data respectively,
the intra prediction unit and inter prediction unit execute intra-frame prediction and inter-frame prediction respectively,
the bit-stream-processing unit includes a variable-length-code-and-decode table,
the variable-length-code-and-decode table has a memory device including a plurality of lookup tables,
codewords contained in the bit stream of the moving picture coded data can be decoded sequentially using the memory device,
decoded values corresponding to the codewords and control information pieces can be stored in the plurality of lookup tables,
one lookup table is selected from among the plurality of lookup tables in decoding one of the codewords, and
in the decode of the one codeword, one decoded value corresponding to the one codeword, and a control information piece for selecting, from among the plurality of lookup tables, a next lookup table depending on the one decoded value and used for a next decode are produced from the one lookup table in response to the one codeword in parallel.

10. The moving-picture decoder according to claim 9, wherein in decode of one other codeword supplied just after the one codeword, one other decoded value corresponding to the other codeword, and an other control information piece for selecting, from the plurality of lookup tables, an other lookup table depending on the other decoded value and used for a next decode are produced from the next lookup table in response to the other codeword in parallel.

11. The moving-picture decoder according to claim 10, wherein each of the codewords is a variable length syntax element encoded according to a predetermined syntax,
decode of a preceding syntax element and decode of a subsequent syntax element are executed sequentially, and
the next lookup table used for the decode of the subsequent syntax element is specified by the control information piece produced in parallel with the one decoded value produced from the one lookup table used for the decode of the preceding syntax element.

12. The moving-picture decoder according to claim 11, wherein the memory device including the plurality of lookup tables is a built-in memory incorporated in a semiconductor integrated circuit.

13. The moving-picture decoder according to claim 12, wherein the built-in memory is a random access memory, and
the decoded value and control information piece stored in the random access memory can be transferred from a nonvolatile memory during an initialization sequence of the semiconductor integrated circuit.

14. The moving-picture decoder according to claim 13, wherein the nonvolatile memory is one of a semiconductor nonvolatile memory incorporated in a system with the semiconductor integrated circuit incorporated therein and a built-in semiconductor nonvolatile memory with the semiconductor integrated circuit incorporated therein.

15. The moving-picture decoder according to claim 11, wherein the codewords making the syntax element are quantization-transform coefficients produced by moving-picture variable length coding.

16. The moving-picture decoder according to claim 15, wherein the moving-picture variable length coding is context-adaptive variable length coding of H.264/AVC,
the codewords have been encoded with syntax elements of run-before values,
in the first decode of one of the codewords of the run-before values, the one lookup table first selected from the plurality of lookup tables is selected according to a total zeros' number, and
the next lookup table used for the decode of the subsequent syntax element is specified by a zeroLeft indicating the control information piece produced from the one lookup table used for the decode of the preceding syntax element.
